(19) United States
(12) Patent Application Publication
(10) Pub. No.: US 2009/0320882 A1
(43) Pub. Date: Dec. 31, 2009

(54) BARBECUE SMOKER

(76) Inventor: Charles Richard Averwater, Cordova, TN (US)

Correspondence Address: KING & SCHICKLI, PLLC, 247 NORTH BROADWAY, LEXINGTON, KY, 40507, US

(21) Appl. No.: 12/492,468

(22) Filed: Jun. 26, 2009

Related U.S. Application Data
(60) Provisional application No. 61/076,401, filed on Jun. 27, 2008.

(51) Int. Cl. A23B 4/044; B08B 9/027; B23P 11/00

(52) U.S. Cl. 134/22.1; 99/482; 29/428

(57) ABSTRACT

A barbecue smoker includes a doorless and lidless cabinet including at least four drawer receiving openings. A first drawer for holding food to be cooked is provided in the first opening. A second drawer for holding a pan of water or seasonings is provided in a second opening. A third drawer for holding fuel for heating the smoker is provided in a third opening. A fourth drawer for receiving and holding ashes produced by the fuel is provided in a fourth opening. All of the drawers include a rear cap to seal a cooking compartment in the cabinet when the drawers are fully open.

This application claims the benefit of U.S. Provisional Patent Application Ser. No. 61/076,401 filed 27 Jun. 2008.

### TECHNICAL FIELD AND INDUSTRIAL APPLICABILITY OF THE INVENTION

This invention relates generally to the field of outdoor cooking devices and, more particularly, to a barbecue smoker including a doorless cabinet as well as a series of drawers.

### BACKGROUND OF THE INVENTION

Outdoor cooking devices including barbecue grills, smokers and the like continue to be very popular with the consuming public. Over the years various designs for barbecue grills and smokers have been developed and many of these are currently available in the marketplace.

One design of particular interest is disclosed in U.S. Pat. No. 4,840,118 to Rinehart. This reference discloses an outdoor grill including an outer cabinet having a pivotally opening hood portion. The cabinet also receives and holds a food-supporting rack assembly in the form of a drawer. A rear wall of the drawer seals the drawer opening in the cabinet when the drawer is fully opened. Finally, a fuel-supporting grate is provided in the bottom of the cabinet.

The Rinehart device does allow one to inspect the food during the cooking operation while maintaining heat and smoke inside the cabinet. This is accomplished by fully opening the drawer assembly so that the rear wall of that assembly closes the drawer opening in the cabinet. It should be appreciated, however, that it is only possible to add fuel to the fuel supporting grate by fully opening the drawer assembly and pivotally opening the hood. Thus, the adding of fuel causes a significant loss of heat and smoke from within the cabinet. This significantly adversely affects the cooking efficiency of the device. When one further considers that it is often necessary to add fuel when cooking large amounts of food and/or competing in a barbecue competition, it is clear that this is a detrimental operating feature.

The present invention relates generally to a barbecue smoker that is doorless and exclusively includes drawers providing full access to the interior of the cabinet so that food may be checked and turned, water may be checked/added, fuel may be checked/added and ashes may be checked/removed from the cabinet while the cabinet is effectively sealed to maintain smoke and heat.

### SUMMARY OF THE INVENTION

In accordance with the purposes of the present invention as described herein, a barbecue smoker is provided comprising a doorless cabinet including at least four drawer receiving openings. A first drawer for receiving and holding food to be cooked in the smoker is provided in a first opening, a second drawer for holding a water pan is provided in a second opening, a third drawer for holding charcoal, wood or other fuel used to heat the food in the smoker is provided in a third opening and a fourth drawer for receiving and holding ashes produced by the fuel used to cook the food in the cabinet is provided in the fourth opening. In one possible embodiment the cabinet is also lidless.

More specifically describing the invention, each drawer includes a rear cap to seal the associated drawer opening when the drawer is fully opened. Further, the cabinet includes a top wall integral with the side walls. That top wall includes an adjustable smoke stack. The side walls include adjustable air intake vents.

In accordance with additional aspects of the present invention, the barbecue smoker includes a series of casters for supporting the cabinet on the ground. In one possible embodiment the barbecue smoker includes a fifth drawer receiving opening and a first additional drawer for receiving and holding food to be cooked in the smoker. In yet another possible embodiment the barbecue smoker includes a sixth drawer receiving opening and a second additional drawer for receiving and holding food to be cooked in the smoker. In yet another possible embodiment the barbecue smoker includes a seventh drawer receiving opening and a third additional drawer for receiving and holding food to be cooked in the smoker.

In accordance with yet another aspect of the present invention the barbecue smoker includes a removable drawer insert frame that is held in the cabinet. Further, the barbecue smoker includes first and second removable drawer slide insert frames held in the cabinet. When these removable frames are removed from the cabinet, one can very easily clean the interior of the cabinet as well as the removable frames in a quick and efficient manner.

In accordance with yet another aspect of the present invention a method is provided of increasing the efficiency of a barbecue smoker. The method includes the steps of: (a) providing the barbecue smoker with a cabinet free of doors, (b) providing openings in the cabinet for receiving a series of drawers wherein at least one of the drawers holds food to be cooked in the cabinet and at least another drawer holds fuel used to cook the food in the cabinet and (c) providing drawers received in the drawer openings in the cabinet incorporating rear caps to seal the drawer openings when the drawers are fully opened. The method may be further described as including the steps of providing a third drawer holding ashes produced by the fuel used to cook the food and a fourth drawer holding water used during cooking of the food to create steam. Still further the method may include the step of providing a cabinet free of an opening lid.

In accordance with yet another aspect of the present invention a method is provided of cleaning a barbecue smoker including a cabinet, multiple drawers, a removable drawer insert flame and first and second removable drawer slide insert frames. The method comprises removing the removable drawer insert frame from the cabinet and washing the cabinet. Still further the method may include removing the first and second removable drawer slide insert frames before washing the cabinet.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a perspective view of a first embodiment of the barbecue smoker of the present invention;

FIG. 2 is a partially exploded perspective view of a cooking drawer used to receive and hold food to be cooked in the smoker;

FIG. 3 is a partially exploded perspective view of a water pan drawer used in the smoker;

FIG. 4 is a partially exploded perspective view of a fire basket drawer used to hold coal, wood or other fuel used to heat the food in the smoker;

FIG. 5 is a partially exploded perspective view of an ash pan drawer used to collect ashes produced by the fuel used to cook the food in the smoker;

FIG. 6 is a partially exploded perspective view illustrating the removable drawer insert frame of the cabinet;

FIG. 7 illustrates the completed cabinet, as well as the removable drawer insert frame, the left drawer slide frame and the right drawer slide flame held in the completed cabinet;

FIG. 8 schematically illustrates how the drawer seats the drawer opening to maintain heat and smoke inside the cabinet when the drawer is fully opened; and

FIG. 9 is a detailed schematical and fragmentary side view illustrating how a removable drawer slide frame is mounted to a cabinet sidewall.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

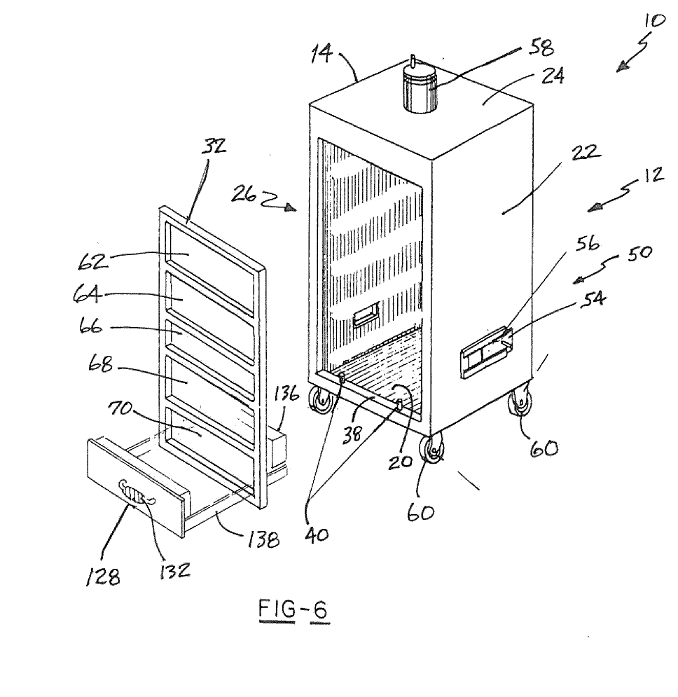

Reference is now made to FIGS. 1 and 6 generally illustrating a barbecue smoker 10 constructed in accordance with the teachings of the present invention. As illustrated, the barbecue smoker 10 is an all drawer design including a doorless and lidless cabinet, generally designated by reference numeral 12. Cabinet 12 includes an outer housing 14 having a front wall 16 a right side wall 18, a bottom wall 20, a left side wall 22, a top wall 24 and a rear wall (not shown). As illustrated in FIGS. 6 and 9, the front wall 16 includes an opening 26. In addition, the cabinet 12 includes a removable first or right drawer slide insert (not shown), a removable second or left drawer slide insert 30 and a removable drawer insert frame 32.

More specifically, as best illustrated in FIG. 9, the left drawer slide inserts 30, including drawer slide 31, is mounted to the side wall 22 by positioning/sliding the top frame crossmember 42 of the insert into a channel in the locater guide 34 provided on the side wall. The left drawer slide insert 30 is then locked into position utilizing the pivoting latch 36 mounted to the left side wall 22. More specifically, the latch 36 is pivoted around the front upright 44 of the left drawer slide insert 30. A similar latch (not illustrated) may be provided adjacent the bottom of the upright 44 to secure it in position at a second point. The right drawer slide insert is secured to the right side wall 18 in the same manner.

The removable drawer insert frame 32 closes the opening 26. The drawer insert frame 32 is mounted to the outer housing 12 by raising the top of the frame 32 upwardly into the gap 46 formed between the angle iron 48 and the front wall 16 and then lowering the frame onto the housing lip 38 and positioning the locator pins 40 provided on that lip in cooperating apertures (not shown) in the bottom face of the removable drawer insert frame 32. The drawer slide insert 30 and drawer insert frame 32 may be easily removed by reversing these procedures.

As further illustrated in FIGS. 1 and 6, each of the side walls 18, 22 includes an adjustable air intake vent 50. In the illustrated embodiment each air intake vent 50 comprises an opening 52 extending through the side wall 18 or 22, a sliding shutter 54 and a shutter guide track 56. The top wall 24 includes an adjustable smoke stack 58. Together, the air intake vents 50 and adjustable smoke stacks 58 allow one to control the air flow through the interior of the cabinet 12 during the cooking of food in the smoker 10. In the illustrated embodiment the top wall 24 is made integral with the side wall 18, 22 so as to provide an aesthetically pleasing seamless construction that also helps to limit loss of heat and smoke from the cooking enclosure formed by the cabinet 12. Four casters 60 are secured to the bottom wall 20. The smoker 10 is supported on the ground on the casters 60 so that it may be conveniently pushed by the operator to a desired location. One or more of the caster 60 may include a brake (not shown) to lock the casters in position and hold the smoker in place.

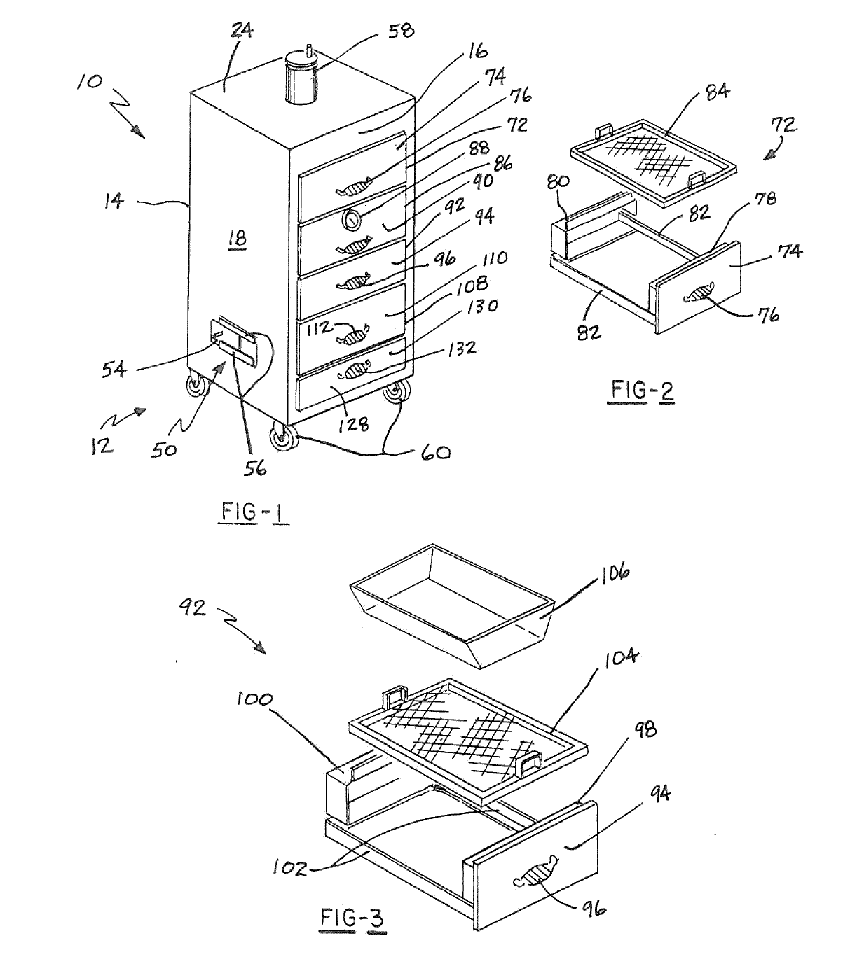

As best illustrated in FIG. 6, the removable drawer insert frame 32 of the insulated cabinet 12 includes a series of five drawer openings 62, 64, 66, 68 and 70. The first drawer opening 62 at the top of the cabinet 12 receives a first drawer 72 that receives and holds food to be cooked in the smoker 10. As best illustrated in FIG. 2, the first drawer 72 incorporates a front face 74 having a handle 76. The front face 74 may include an insulated liner 78. In addition the drawer 72 includes a rear cap 80. Two rails 82 interconnect the front face 74 with the rear cap 80. A removable grate 84 spans between the rails 82, the front face 74 and the rear cap 80. The grate 84 provides a surface for holding the food to be cooked in the smoker.

A second drawer 86 is received in the second drawer opening 64 of the cabinet 12. The second drawer 86 is constructed virtually identical to the first drawer 72. However, in the illustrated embodiment the second drawer 86 includes a thermometer 88 in the face of the drawer 90 that allows the operator to monitor the temperature of the cooking compartment inside the cabinet 12. A third drawer 92 is received in the third drawer opening 66 of the cabinet 12. As best illustrated in FIG. 3, the third drawer 92 is constructed similar to the first drawer 72 and includes a front face 94, a handle 96, an insulated liner 98, a rear cap 100 and rails 102. Similarly, a grate 104 bridges the area between the rails 102, the front face 94 and the rear cap 100. A pan 106 is received on the grate 104. The pan 106 may hold water or other appropriate solid or liquid materials which may be used to steam and/or season the food being cooked in the smoker 10.

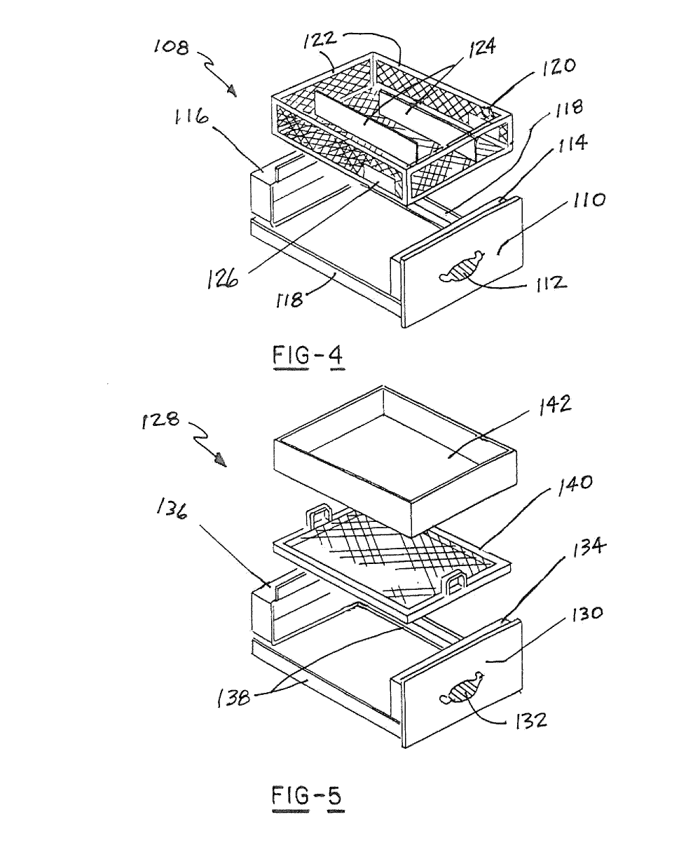

A fourth drawer 108 is received in the fourth drawer opening 68. The fourth drawer 108 is illustrated in FIG. 4. The fourth drawer 108, like the first drawer 72 includes a front face 110, a handle 112, an insulated liner 114, a rear cap 116 and cooperating rails 118. In addition, the fourth drawer 108 includes a removable grate or basket 120 having upstanding side walls 122 for receiving and holding fuel such as wood, charcoal and the like used to create heat inside the smoker 10. As illustrated the basket 120 may include removable partitions 124. In addition, the basket 120 may include an opening 126 in one of the side walls of the basket 120 sized and shaped to receive the electrical element of a charcoal starter of a type well known in the art.

A fifth drawer 128 is received in the fifth drawer opening 70. The fifth drawer 128, like the other drawers 72, 86, 92 and 108 includes a front face 130, a handle 132, an insulated liner 134, a rear cap 136 and cooperating rails 138. The fifth drawer 128 includes a removable grate 140 that spans between the rails 138, the front face 130 and the rear cap 136. The grate 140 provides a surface for holding a box 142 that receives ashes produced as the fuel in the basket 120 burns.

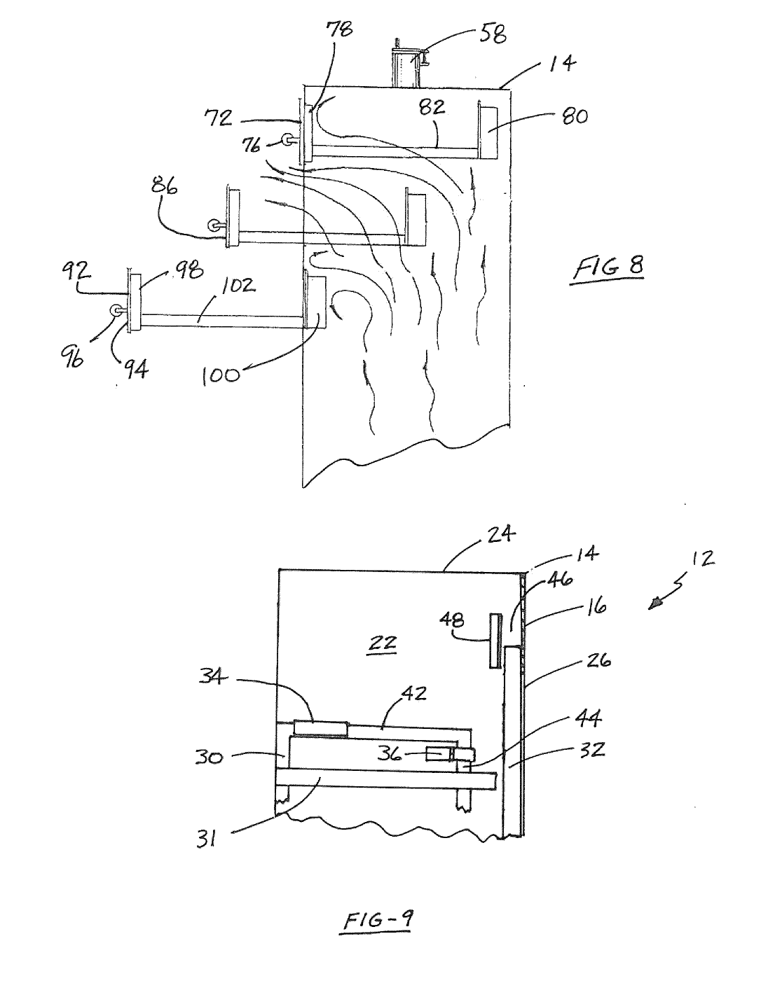

As best illustrated in FIG. 1, when the drawers 72, 86, 92, 108 and 128 are all fully closed, they seal the drawer openings 62, 64, 66, 68, 70 in the cabinet 12. As further illustrated in FIG. 8, it should also be appreciated that each of the drawers 72, 86, 92, 108 and 128 seals its respective opening 69, 64, 66, 68, 70 when that drawer is fully opened. More specifically, as illustrated, when a drawer 72, 86, 92, 108 and 128 is fully opened, the rear cap 80, 100, 116 or 136 of that drawer seals the back side of the opening 62, 64, 66, 68, 70. Thus, the openings 62, 64, 66, 68, 70 of the cabinet 12 are always sealed when all of the drawers 72, 86, 92, 108 and 128 are either fully opened or fully closed. This allows the operator to maintain substantially all of the heat and smoke in the cooking compartment 12, effectively minimizing the loss of heat and smoke to that that is allowed to escape as any of the drawers are actually being opened or closed. As a result of this unique arrangement an operator may open the first or second drawer 72, 86 to inspect the food being cooked or open the third drawer 92 to inspect, change or add to the water or other seasonings, open the fourth drawer 108 to inspect or add to the fuel and/or open the fifth drawer 128 to inspect or remove ashes while maintaining smoke and heat in the cooking compartment inside the cabinet 12. This allows the operator to maintain a more consistent temperature in the smoker 10 allowing the operator to cook the food more effectively to a desired temperature. Further, since the loss of heat and smoke is minimized, cooking is completed more efficiently.

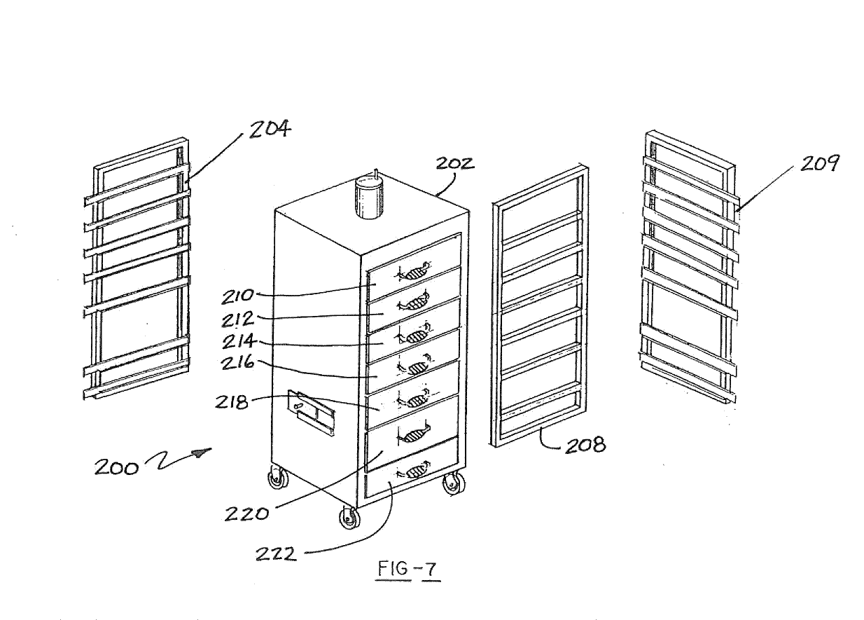

An alternative embodiment of the present invention is illustrated in FIG. 7. As should be appreciated this embodiment of the smoker 200 includes a cabinet 202 with housing walls substantially corresponding to those walls 16, 18, 20, 92 and 24 of the first embodiment illustrated in FIG. 1. The first or right drawer slide insert 204, second or left drawer slide insert 209 and the removable drawer insert frame 208 are, however, designed to accommodate seven drawers rather than five drawers. The top four drawers 210, 212, 214 and 216 are like the first and second drawers 72, 86 of the first embodiment and are adapted to receive and hold food to be cooked in the smoker 200. The fifth drawer 218 is like the drawer 92 illustrated in FIG. 3 and includes a pan for holding water, other seasonings or the like. The sixth drawer 220 is like the drawer 108 illustrated in FIG. 4 and is adapted to receive and hold the fuel used to heat the cooking compartment inside the smoker 200. Lastly, the seventh drawer 222 is like the drawer 130 illustrated in FIG. 5 and is adapted to receive and hold ashes produced by the fuel during the cooking process.

It should be appreciated that either of the embodiments of smoker 10, 200 include the removable drawer slide inserts 28, 30 or 204, 206 and removable drawer insert frames 32 or 208. It should be further appreciated that the removable drawer slide inserts 28, 30 or 204 206 and removable drawer insert frames 32 or 208 may be relatively easily removed from the housing 14 of the cabinet 12 thereby fully uncovering the opening 26 (see FIG. 6) of the cabinet 12 so that the interior of the housing 14 may be fully and easily cleaned. Similarly, the inserts 28, 30, 204, 206 and frames 32, 208 may also be easily cleaned once they are removed from the cabinet. This allows one to more conveniently and effectively complete the cleaning operation in the most efficient mariner possible.

In summary, numerous benefits result from employing the concepts of the present invention. Food being cooked may be checked and turned, water or other seasonings may be checked and/or changed, the fuel may be checked and replenished and even the ashes may be checked and removed when the smoker is in use while simultaneously minimizing the loss of any smoke or heat from the cooking compartment. This allows for more efficient cooking. Further, the removable drawer slide inserts 28, 30, 204, 206 and removable drawer insert frames 312 and 208 allow one to quickly and effectively clean the cabinet and those inserts in all efficient manner.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, the cabinet could include a lid that may be opened when cleaning the cabinet. It should be appreciated, however, that it would be unnecessary to open the lid during the cooking operation for any purpose including to check/turn the food, check/replenish water, check/replenish the fuel and check/remove ashes. Thus, any loss of smoke and heat that would otherwise be associated with any opening of the lid is avoided.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A barbecue smoker comprising:
a door-less cabinet including at least four drawer receiving openings;
a first drawer for receiving and holding food to be cooked in the smoker;
a second drawer for holding a water pan;
a third drawer for holding coal, wood or other fuel used to heat the food in the smoker; and
a fourth drawer for receiving and holding ashes produced by the fuel used to cook the food ill the cabinet.

2. The barbecue smoker of claim 1, wherein each drawer includes a rear cap to seal the opening that receives the drawer when the drawer is fully opened.

3. The barbecue smoker of claim 2, further including a series of casters for supporting the cabinet on the ground.

4. The barbecue smoker of claim 3, further including a top wall integral with said side walls, said top wall including an adjustable smoke stack and said sidewalls including adjustable air intake vents.

5. The barbecue smoker of claim 1, including a fifth drawer receiving opening and a first additional drawer for receiving and holding food to be cooked in said smoker.

6. The barbecue smoker of claim 5, including a sixth drawer receiving opening and a second additional drawer for receiving and holding food to be cooked in said smoker.

7. The barbecue smoker of claim 6, including a seventh drawer receiving opening and a third additional drawer for receiving and holding food to be cooked in said smoker.

8. The barbecue smoker of claim 7, wherein said cabinet includes a removable drawer insert frame.

9. The barbecue smoker of claim 8, wherein said cabinet further includes first and second removable drawer slide insert frames.

10. The barbecue smoker of claim 1, wherein said cabinet further includes first and second removable drawer slide insert frames.

11. The barbecue smoker of claim 10, wherein said cabinet further includes a cooperating locator guide and latch to secure each of said first and second removable drawer slide insert frames in position on opposing sidewalls of said cabinet.

12. The barbecue smoker of claim 10, wherein said cabinet further includes first and second removable drawer slide insert frames.

13. The barbecue smoker of claim 12, wherein said cabinet further includes a cooperating locator guide and latch to secure each of said first and second removable drawer slide insert frames in position on opposing sidewalls of said cabinet.

14. The barbecue smoker of claim 1, wherein said cabinet is also lid-less.

15. A method of increasing the efficiency of a barbecue smoker, comprising:
providing said barbecue smoker with an insulated cabinet free of doors:
providing openings in said cabinet for receiving a series of drawers wherein at least one of said drawers holds food to be cooked in said cabinet and at least another of said drawers holds fuel used to cook food in said cabinet; and
providing drawers received in said openings in said cabinet that incorporate rear caps that seal the drawer openings when the drawers are fully opened.

16. The method of claim 15, including providing a third drawer holding ashes produced by said fuel used to cook the food.

17. The method of claim 16, including providing a fourth drawer holding water used during cooking of the food to create steam.

18. The method of claim 17, including providing said cabinet free of an opening lid.

19. A method of cleaning a barbecue smoker including a cabinet, multiple drawers, a removable drawer insert frame and first and second removable drawer slide insert frames, comprising:
removing said removable drawer insert frame from said cabinet; and
washing said cabinet.

20. The method of claim 19, further including removing said first and second removable drawer slide insert frames before washing said cabinet.
